(19) United States
(12) Patent Application Publication
(10) Pub. No.: US 2010/0081048 A1
(43) Pub. Date: Apr. 1, 2010

(54) PRISMATIC SECONDARY BATTERY AND BATTERY MODULE THEREOF

(75) Inventors: Kenji Nansaka, Habikino-shi (JP); Yasuhiro Yamauchi, Sumoto-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/565,970

(22) Filed: Sep. 24, 2009

(30) Foreign Application Priority Data
Sep. 29, 2008 (JP) 2008-249430

(51) Int. Cl. H01M 10/04; H01M 2/30

(52) U.S. Cl. 429/158; 429/178

(57) ABSTRACT

A negative electrode terminal 19 and a positive electrode terminal 18 of a prismatic secondary battery 12 of the present invention are provided with terminal plates 20A and 20B, respectively, that are electrically connected to a negative electrode plate and a positive electrode plate, respectively, and with insulating materials 21A and 21B, respectively, that electrically insulate the terminal plates 20A and 20B, respectively, from a sealing plate 17. The insulating materials 21A and 21B are provided with connecting portions 24A and 24B, respectively, that are formed with connection contact portions composed of recessed portions 27 and protruding portions 31, respectively, having shapes complementary with each other. According to the prismatic battery 12 of the invention, any number of the batteries can easily be connected without a mistake in polarity to obtain a modularized battery.

### TECHNICAL FIELD

The present invention relates to a prismatic secondary battery and to a battery module using a plurality of these batteries. In more detail, the invention relates to a prismatic secondary battery, a plurality of which can easily be connected without a mistake in polarity when being modularized, and to a battery module using the plurality of prismatic secondary batteries.

### BACKGROUND ART

An individual battery has a low electromotive force. Even a lithium ion battery that is said to have a relatively high electromotive force has an electromotive force of as low as approximately 4 volts. In the case of using the battery for high-power applications such as an electric vehicle, so-called modularization is used in which a plurality of batteries are connected in series. This modularization is achieved, for example, by using a method in which a positive electrode terminal and a negative electrode terminal of each battery are extended, then these extended terminals are folded toward each other, and finally the adjacent positive electrode terminal and negative electrode terminal are overlapped and welded to be connected to each other, or a method in which the adjacent positive electrode terminal and negative electrode terminal are screw-connected to each other with bolts and nuts by using a connecting member such as a bus bar. Of these connection methods, the latter screw connection method using bolts and nuts is commonly employed.

Here, an example of a battery module employing the screw connection method according to the related art will be described with reference to FIG. 6. Note that FIG. 6 is an external perspective view showing the battery module employing the screw connection method according to the related art.

This battery module 100 is modularized by serially connecting a plurality, such as three, of lithium ion secondary batteries (hereinafter called simply “batteries”) 101 to 103. Each of these batteries has a prismatic battery outer can 100A with an open mouth at the upper end and a sealing plate 100B installed to seal the mouth. A positive electrode terminal 104B and a negative electrode terminal 104A project from the upper surface of the sealing plate 100B.

Each of the positive electrode terminal 104B and the negative electrode terminal 104A is composed of a terminal plate 105 of a flat-plate shape and an insulating material 106 that electrically insulates this terminal plate 105 from the sealing plate 100B. The terminal plate 105 has an elongated rectangular shape, with one end thereof fixed with a bolt 107 in an upright manner and with the other end thereof formed with an insert through-hole in which a terminal 109 is inserted. The insulating material 106 has the substantially same planar shape as that of the terminal plate 105, and is provided with a similar insert through-hole to that of the terminal plate 105 at a location corresponding to the insert through-hole of the terminal plate 105.

To install the positive electrode terminal 104B and the negative electrode terminal 104A on the sealing plate 100B, first, the insulating material 106 and the terminal plate 105 are stacked in this order on the upper surface of the sealing plate 100B; then, the insert through-holes of the terminal plate 105 and the insulating material 106 are aligned to a terminal hole provided in the sealing plate 100B; further, a terminal connected to a collector located inside is inserted into the insert through-holes from the terminal hole; and finally, a portion of this terminal projecting from the insert through-hole of the terminal plate 105 is fixed by laser-welding or other method.

To perform the modularization, first, the three batteries 101 to 103 are arranged so that adjacent terminals of the batteries have different polarities from each other. Next, a connecting bus bar 108 is mounted between the bolts 107 of the two adjacent batteries, for example, of the battery 102 and the battery 103, and then nuts, which are not shown, are mounted to these bolts 107 to connect the batteries with the connecting bus bar 108, thus the battery module 100 being fabricated.

In addition, a battery module disclosed in JP-A-2005-322647 described below will be explained by using FIG. 7. Note that FIG. 7 is an exploded perspective view showing a structure of the battery module described in JP-A-2005-322647 below.

This battery module 200 has a structure in which a spacer 208 is provided between cap assemblies 203 of unit cells 201 and connectors 206 mounted on positive electrode terminals 204 and negative electrode terminals 205. The spacer 208 is formed into a bar shape extended along a terminal row composed of the adjacent positive electrode terminals 204 and negative electrode terminals 205 of the plurality of arranged unit cells 201. The length of this spacer 208 is set to a length corresponding to the battery module, specifically to a length corresponding to a total length L of short sides of the unit cells 201 arranged in a row. The spacer 208 is provided with insert through-holes 209 in which the terminals of the unit cells 201 are inserted at a constant interval in the longitudinal direction, and the lower side of the spacer 208 is formed with fitting grooves 210, each of which fits with a case 202 of each of the unit cells 201. The fitting groove 210 is formed to have a width substantially the same as the width of the case 202 of the unit cell 201 so that the case 202 fitting in the fitting groove 210 does not move in the fitting groove 210.

The battery module 200 is assembled as follows. First, the positions of the insert through-holes 209 provided in the spacer 208 are aligned to corresponding positions of the positive electrode terminals 204 and the negative electrode terminals 205 of the unit cells 201, and the spacer 208 is installed. As a result of this installation, the spacer 208 is arranged on top of the cap assemblies 203. Thus, each of the two spacers 208 is installed on each of the terminal rows in a manner arranged along each of the two terminal rows that are composed of the positive electrode terminals 204 and the negative electrode terminals 205 of the unit cells 201. Next, the adjacent positive electrode terminals 204 and negative electrode terminals 205 are fastened by using the connectors 206 and nuts 207 so that the unit cells 201 are serially connected to each other, thereby obtaining the battery module 200. With the connection structure as described above, because the spacer 208 serving as a nonconductor of insulating material is located between the cap assembly 203 of the unit cell 201 and the connector 206, the cap assembly 203 and the connector 206 that are made of metal material are not electrically shorted.

In the battery module 100 according to the related art, the connecting bus bar 108 is mounted between the two bolts 107 of the two adjacent batteries, for example, of the batteries 102 and 103, and then the nuts, which are not shown, are mounted to these bolts 107 to fasten the connecting bus bar 108. In this fastening operation, the bolt 107 is subjected to a screwing force in the clockwise direction (arrow A1 in FIG. 6) when the nut is tightened by screwing. On the other hand, because the other end of the terminal plate 105 is connected, by welding or other method, to the terminal 109 that is connected to the collector, a turning load may be generated about the axis of the terminal 109 due to the screwing force applied to the bolt 107 that is connected to this terminal plate 105.

That is, the terminal plate 105 is integrally connected to the axis of the terminal 109. Therefore, in the case that the connecting bus bar 108 is not mounted, the terminal plate 105 moves in a swinging manner in the clockwise or counterclockwise direction about the axis of the terminal 109 as an axial center if a strong force is applied when the bolt 107 of the terminal plate 105 is fastened. In addition, the swinging movement as described above can also occur when the connecting bus bar 108 is fixed by fastening with bolts and nuts after being mounted between the two bolts 107. If the turning load is generated about the terminal 109, the axis of the terminal 109 turns in the direction of arrow A2. Therefore, there are potential problems caused by a harmful effect on the connection of the axis of the terminal 109 to the collector, such as a poor connection or increase in internal resistance due to the poor connection, or, furthermore, a poor seal between the terminal and the sealing plate 100B resulting in an outward leakage of electrolyte.

In addition, although the individual batteries of this battery module 100 are connected in series, desired output is not obtained if the batteries are connected with a wrong polarity. Therefore, in order to eliminate such an error in a manufacturing shop, the positive electrode terminal and the negative electrode terminal are distinguished from each other, for example, by using colors different from each other. However, even using such a method, erroneous connections can occur due to carelessness of workers and so on.

On the other hand, according to the battery module of JP-A-2005-322647 described above, the swinging movement suffered by the related art described above is not likely to occur because the plurality of cells are connected by using the long spacers 208 of length L. However, because the long spacers 208 are used, the number of the cells that can be connected is limited by the spacer length, thus making it impossible to install more cells or to adjust the number of connected cells. Moreover, not only the spacers of a special shape are required as additional parts, but also there is still a possibility that the plurality of cells are erroneously connected.

### SUMMARY

An advantage of some aspects of the present invention is to provide a prismatic secondary battery that is suitable for modularization by easily connecting a plurality of any number of the batteries without a mistake in polarity, and a battery module using the plurality of prismatic secondary batteries.

According to a first aspect of the invention, a prismatic secondary battery includes a battery outer can of a prismatic shape that has a bottom and an open mouth at the top, an electrode assembly that is housed in the battery outer can and formed by stacking or spirally winding a positive electrode plate and a negative electrode plate with a separator interposed therebetween, and a sealing plate that seals the mouth and is provided on the upper surface with a positive electrode terminal and a negative electrode terminal. The positive electrode terminal and the negative electrode terminal are provided with terminal plates that are electrically connected to the positive electrode plate and the negative electrode plate, respectively, and with insulating materials that electrically insulate the terminal plates from the sealing plate. The insulating materials of the positive electrode terminal and the negative electrode terminal are provided with a positive electrode connecting portion and a negative electrode connecting portion, respectively, that have connection contact portions having shapes complementary with each other. The shapes of the positive electrode connecting portion and the negative electrode connecting portion are such that, when a plurality of the prismatic secondary batteries are arranged in parallel so that adjacent terminals have different polarities from each other, the positive electrode connecting portion and the negative electrode connecting portion of one prismatic secondary battery are connected in contact with the negative electrode connecting portion and the positive electrode connecting portion, respectively, of an adjacent prismatic secondary battery, through the connection contact portions having shapes complementary with each other.

In the prismatic secondary battery according to the first aspect of the invention, the positive electrode terminal and the negative electrode terminal are provided with the positive electrode connecting portion and the negative electrode connecting portion, respectively, that have the connection contact portions having the shapes complementary with each other. In addition, the shapes of the positive electrode connecting portion and the negative electrode connecting portion are such that, when the plurality of prismatic secondary batteries are arranged in parallel so that the adjacent terminals have different polarities from each other, the positive electrode connecting portion and the negative electrode connecting portion of one prismatic secondary battery are connected in contact with the negative electrode connecting portion and the positive electrode connecting portion, respectively, of an adjacent prismatic secondary battery, through the connection contact portions having the shapes complementary with each other. Therefore, with the prismatic secondary battery according to the first aspect of the invention, it is possible to obtain a prismatic secondary battery, any number of which can easily be connected without a mistake in polarity when a plurality of the batteries are connected into a module.

Also, in the secondary battery according to the first aspect of the invention, the insulating materials may preferably have projecting portions that protrude the positive electrode connecting portion and the negative electrode connecting portion by a certain predetermined length, from at least one side in the longitudinal direction of the sealing plate, toward a direction perpendicular to the longitudinal direction of the sealing plate, and connection contact sides at the ends of the projecting portions may preferably be formed with the connection contact portions having the shapes complementary with each other.

With the prismatic secondary battery according to the first aspect of the invention, the insulating materials have the projecting portions that protrude by a certain predetermined length. Therefore, when the plurality of batteries are connected into a module, gaps can be provided between adjacent batteries at predetermined space intervals, and by providing these gaps, it becomes possible to efficiently radiate the heat generated from each of the prismatic secondary batteries when using or charging the batteries, thus enabling the batteries to be charged or discharged at a desired power.

Moreover, in the prismatic secondary battery according to the first aspect of the invention, the projecting portions may preferably protrude by the same length from both sides in the longitudinal direction of the sealing plate, toward a direction perpendicular to the longitudinal direction of the sealing plate.

With the prismatic secondary battery according to the first aspect of the invention, the projecting portions protrude by the same length from both sides in the longitudinal direction of the sealing plate, toward a perpendicular direction thereto. Therefore, in the case of connecting three or more of the prismatic secondary batteries, all of the gaps between adjacent batteries can have the same space interval.

In addition, in the prismatic secondary battery according to the first aspect of the invention, the terminal plates may preferably be provided with connection portions to which collectors are connected and with external terminals that are externally connected in positions spaced apart from the connection portions, and the positive electrode connecting portion and the negative electrode connecting portion of the insulating materials may preferably be provided at locations corresponding to the connection portions or to the external terminals.

With the secondary battery according to the first aspect of the invention, the terminal plates are provided with the connection portions to which the collectors are connected and with the external terminals that are externally connected in the positions spaced apart from these connection portions, and the positive electrode connecting portion and the negative electrode connecting portion of the insulating materials are provided at the locations corresponding to the connection portions or to the external terminals. Therefore, even if an external force is applied to the external terminal, for example, during connection, transmission of the external force to the connection portion to which the collector is connected is reduced, thus preventing an occurrence of, for example, a poor connection between the collector and the connection portion.

In the prismatic secondary battery according to the first aspect of the invention, the external terminals may preferably be composed of fasteners that are selected from bolts or nuts.

By having the external terminal composed of a fastener that is selected from a bolt or a nut, a bus bar connected to this external terminal can be tightly fixed with the nut or the bolt. Therefore, with the prismatic secondary battery according to the first aspect of the invention, because contact resistance at the external terminal can be reduced, a power loss at this external terminal can be reduced, thus enabling a prismatic secondary battery capable of producing a large power output to be obtained. It should be noted that, in the case of a related-art prismatic secondary battery, a large external force may be applied when tightening the external terminal if the external terminal is composed of a bolt or a nut as a fastener. However, in the prismatic secondary battery according to the first aspect of the invention, the positive electrode connecting portion and the negative electrode connecting portion of the insulating materials are provided at the locations corresponding to the connection portions or to the external terminals. Therefore, transmission of the external force to the connection portion to which the collector is connected is reduced, thus suppressing an occurrence of a poor connection between the collector and the connection portion.

In addition, because the connection portion and the external terminal are located apart from each other, the turning axis when tightening the external terminal with a bolt and a nut does not coincide with the turning axis of the connection portion, thus making the connection portion difficult to turn when the bolt and nut are tightened. Consequently, the connection of the connection portion to the collector can be prevented from suffering harmful effects, such as a poor connection or increase in internal resistance due to the poor connection, or, furthermore, a poor seal between the terminal and the sealing plate.

Also, in the prismatic secondary battery according to the first aspect of the invention, one and the other of the connection contact portions having shapes complementary with each other may preferably be a recessed portion and a protruding portion, respectively.

With the secondary battery according to the first aspect of the invention, the connection contact portions of the insulating materials can complement each other with simple shapes, such as the recessed portion on one side and the protruding portion on the other side. Therefore, no high cost is particularly required to form the connection contact portions, and yet the plurality of prismatic secondary batteries can be connected through contact in a reliable manner.

Moreover, in the prismatic secondary battery according to the first aspect of the invention, the terminal plates may preferably be fixed in place by anti-rotation units formed on the insulating materials.

With the prismatic secondary battery according to the first aspect of the invention, the terminal plates can be fixed in place in a reliable manner because the anti-rotation units are formed on the insulating materials. Therefore, the terminal plates not only are easily assembled, but also can be prevented from being moved or turned carelessly.

Furthermore, a battery module according to a second aspect of the invention includes a plurality of the prismatic secondary batteries according to the first aspect of the invention that are connected in series in such a manner that the positive electrode connecting portion and the negative electrode connecting portion that are adjacent to each other are connected in contact with each other, and the different polarity terminals of the prismatic secondary batteries that are adjacent to each other are firmly connected to each other by a connecting bus bar.

With the battery module according to the second aspect of the invention, any number of the prismatic secondary batteries can be connected into a module in a low-cost and simple manner without a mistake in polarity by processing the insulating materials, while not using the special spacers as additional parts, as are used in the related art. In addition, because the certain predetermined gaps are provided between the adjacent batteries connected to each other, it is possible to radiate the heat generated from each of the prismatic secondary batteries when using or charging the batteries, thus enabling the batteries to be charged or discharged at a desired power. Moreover, even if an external force is applied to the external terminal, for example, during connection, transmission of the external force to the connection portion to which the collector is connected is reduced, thus preventing an occurrence of, for example, a poor connection. Particularly, although a large external force is applied when tightening the external terminal if the external terminal uses a bolt or a nut as a fastener, the transmission of the external force to the connection portion to which the collector is connected is reduced, thus suppressing the occurrence of the poor connection between the collector and the connection portion.

### BRIEF DESCRIPTION OF THE DRAWINGS

The invention will be described with reference to the accompanying drawings, wherein like numbers reference like elements.

FIG. 1 is an external perspective view of a battery module formed by connecting a plurality of prismatic secondary batteries according to an exemplary embodiment.

FIG. 2 is an external perspective view of one of the secondary batteries constituting the prismatic secondary battery module of FIG. 1.

FIG. 3A is a plan view of a terminal plate of a negative electrode terminal; FIG. 3B is a cross-sectional view along line IIIB-IIIB in FIG. 3A; FIG. 3C is a plan view of an insulating material of the negative electrode terminal; and FIG. 3D is a cross-sectional view along line IIID-IIID in FIG. 3C.

FIG. 4A is a plan view of a terminal plate of a positive electrode terminal; FIG. 4B is a cross-sectional view along line IVB-IVB in FIG. 4A; FIG. 4C is a plan view of an insulating material of the positive electrode terminal; and FIG. 4D is a cross-sectional view along line IVD-IVD in FIG. 4C.

FIG. 5 is a partial cross-sectional view along line V-V in FIG. 2.

FIG. 6 is an external perspective view of a related-art battery module.

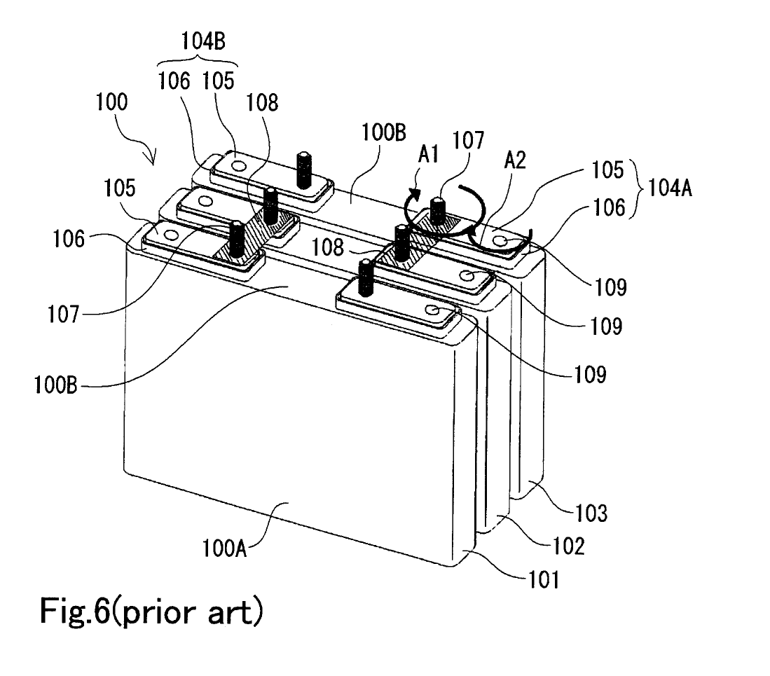

FIG. 7 is an exploded perspective view of another related-art battery module.

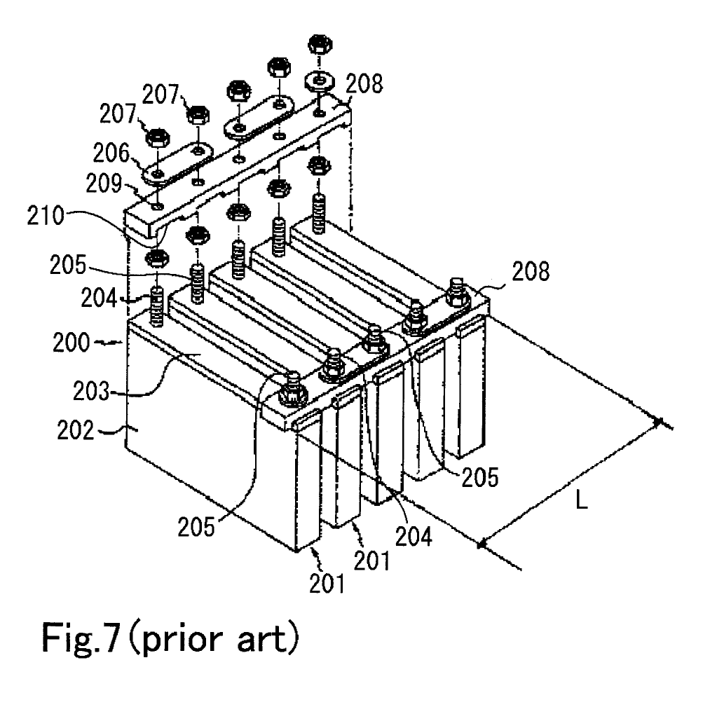

### DESCRIPTION OF EXEMPLARY EMBODIMENTS

An exemplary embodiment of the invention will now be described with reference to the accompanying drawings. However, it should be understood that the embodiment below is intended by way of illustrative examples of a prismatic secondary battery and a battery module using these prismatic secondary batteries that carry out the technical concepts of the invention, and is not intended by way of limiting the invention to these particular examples. The invention could equally well be applied to yield other embodiments within the scope and spirit of the claims.

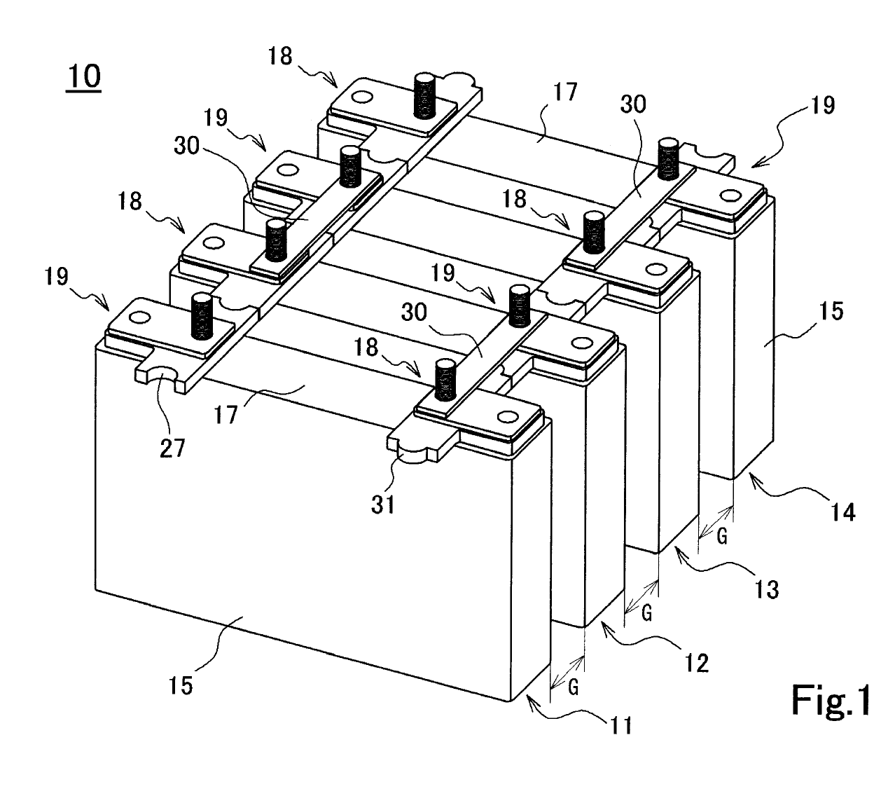

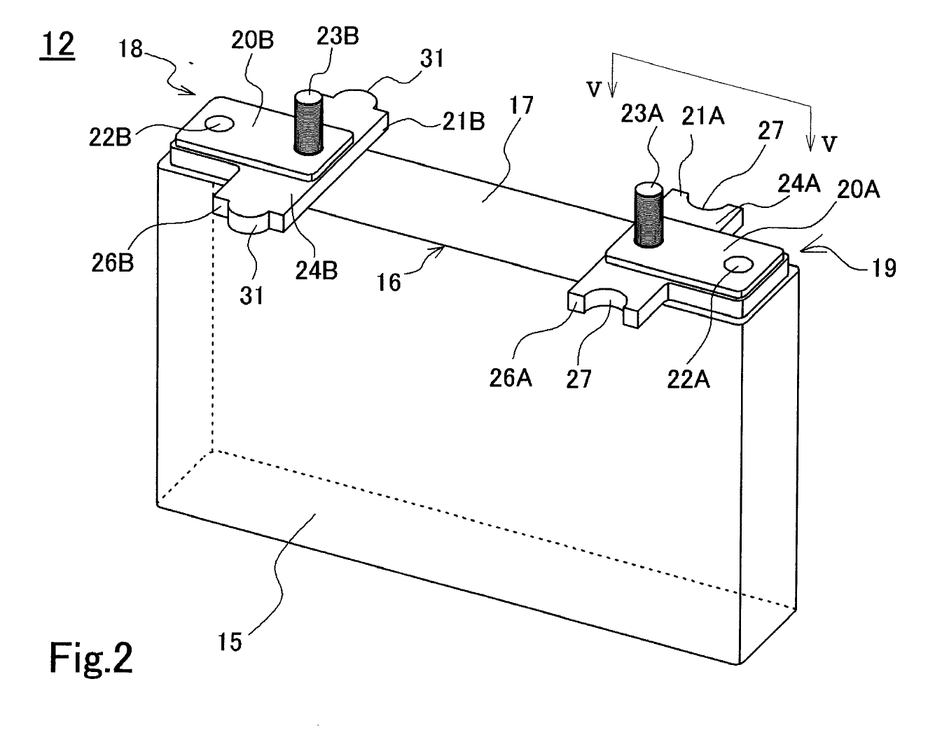

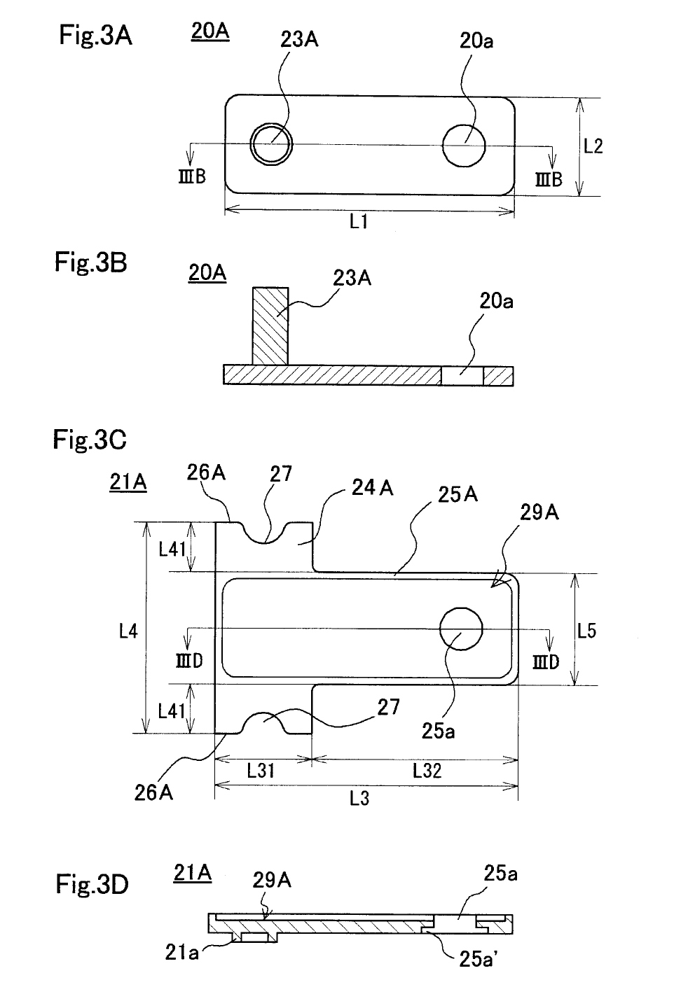

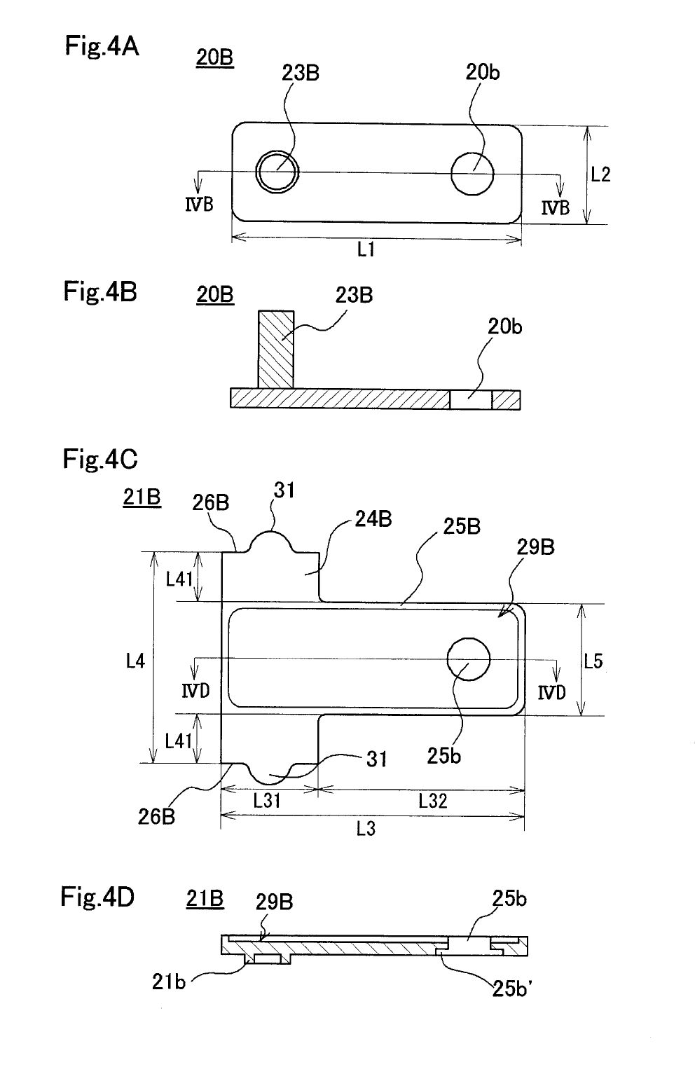

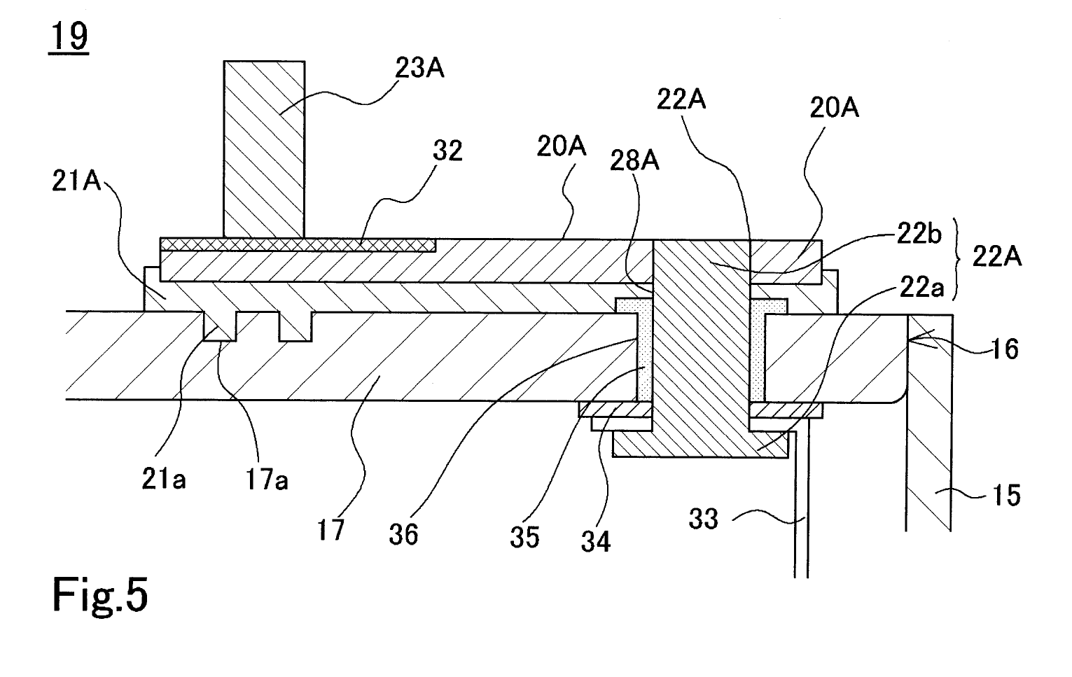

FIG. 1 is an external perspective view of a battery module formed by connecting a plurality of prismatic secondary batteries according to the exemplary embodiment. FIG. 2 is an external perspective view of one of the prismatic secondary batteries constituting the battery module of FIG. 1. FIG. 3A is a plan view of a terminal plate of a negative electrode terminal; FIG. 3B is a cross-sectional view along line IIIB-IIIB in FIG. 3A; FIG. 3C is a plan view of an insulating material of the negative electrode terminal; and FIG. 3D is a cross-sectional view along line IIID-IIID in FIG. 3C. FIG. 4A is a plan view of a terminal plate of a positive electrode terminal; FIG. 4B is a cross-sectional view along line IVB-IVB in FIG. 4A; FIG. 4C is a plan view of an insulating material of the positive electrode terminal; and FIG. 4D is a cross-sectional view along line IVD-IVD in FIG. 4C. FIG. 5 is a partial cross-sectional view along line V-V in FIG. 2.

First of all, structures of a prismatic secondary battery and a battery module according to the embodiment of the invention will be described with reference to FIGS. 1 and 2. As shown in FIG. 1, a battery module 10 has a modularized structure formed by serially connecting a plurality, such as four, of lithium ion prismatic secondary batteries (hereinafter called simply “batteries”) 11 to 14. All of these batteries 11 to 14 have an identical shape. Therefore, the battery 12 serving as one of these batteries 11 to 14 will be specifically described by using FIG. 2, which is a perspective view.

This battery 12 has an outer can 15 for a prismatic secondary battery that is made of metal and formed with a mouth portion 16 at the top end, and a sealing plate 17 that is made of metal and installed to seal the mouth portion 16 of the outer can 15. This sealing plate 17 is welded to the rim of the mouth portion 16 of the outer can 15, forming a structure of hermetically sealing the inside of the battery 12. A positive electrode plate, a negative electrode plate, a separator, and an electrolyte, which are not shown, are housed in the outer can 15. In addition, the upper surface of the sealing plate 17 is provided with a positive electrode terminal 18 and a negative electrode terminal 19.

The positive electrode plate is made by applying a positive electrode active material mixture containing, for example, lithium composite oxide in a form of thin layer onto both surfaces of a positive electrode substrate composed of aluminum or aluminum-alloy foil. This positive electrode substrate composed of aluminum or aluminum-alloy foil is electrically connected to the positive electrode terminal 18 via a positive electrode collector composed of the same aluminum or aluminum-alloy material. In a similar manner, the negative electrode plate is made by applying a negative electrode active material mixture containing, for example, carbon material in a form of thin layer onto both surfaces of a negative electrode substrate composed of copper or copper-alloy foil. This negative electrode substrate composed of copper or copper-alloy foil is connected to the negative electrode terminal 19 via a negative electrode collector composed of the same copper or copper-alloy material.

Specific examples of manufacturing the positive electrode plate and the negative electrode plate, and of fabrication of the battery 12 will be described below. The positive electrode plate is manufactured as follows. A positive electrode active material composed, for example, of lithium cobalt oxide is mixed with a carbon powder such as acetylene black or graphite, and with a binding agent composed of polyvinylidene fluoride (PVDF) in proportions of 94%, 3%, and 3% by mass, respectively. Then, N-methylpyrrolidone is added to the mixture and stirred to prepare the positive electrode active material slurry. This positive electrode active material slurry is applied evenly onto both surfaces of the positive electrode substrate composed of the aluminum foil with a thickness of 20 μm so that an exposed portion of the positive electrode substrate is provided at an end of the electrode, thus forming the positive electrode plate coated with active material layers. Then, the positive electrode plate coated with the active material layers is passed through a drier to be cleared of the organic solvent that was required when preparing the slurry and to be dried. After being dried, this dry positive electrode plate is rolled in a roll press into a positive electrode plate with a thickness of 0.06 mm. The electrode thus manufactured is then cut into a strip of 55.5 mm wide to obtain a positive electrode plate provided with a 10 mm wide strip-shaped exposed portion of the positive electrode substrate.

The negative electrode plate is manufactured as follows. First, a graphite powder, carboxymethyl cellulose, and styrene-butadiene rubber are mixed in proportions of 98%, 1%, and 1% by mass, respectively. Then, water is added to the mixture and stirred to prepare a slurry. This slurry is applied evenly onto both surfaces of the negative electrode substrate composed of the copper foil with a thickness of 12 μm so that an exposed portion of the negative electrode substrate is provided at an end of the electrode, thus obtaining the negative electrode plate coated with negative electrode active material layers. Then, the negative electrode plate coated with the active material layers is passed through a drier to be cleared of the water that was required when preparing the slurry and to be dried. After being dried, this dry negative electrode plate is rolled in a roll press into a negative electrode plate with a thickness of 0.05 mm. Next, the electrode thus obtained is cut into a strip of 55.5 mm wide to obtain a negative electrode plate provided with a 10 mm wide strip-shaped exposed portion of the negative electrode substrate.

The exposed portion of the positive electrode substrate of the above-obtained positive electrode plate and the exposed portion of the negative electrode substrate of the above-obtained negative electrode plate are displaced from each other so as not to overlap the active material layers of the corresponding opposing electrodes, and then the electrode plate are wound with a microporous polyethylene separator of 0.022 mm thick interposed therebetween to produce a flat wound electrode group that is formed at both ends thereof with the exposed portion of the positive electrode substrate and the exposed portion of the negative electrode substrate. Next, the collectors pasted with insulating seal materials around welding portions thereof are joined to the exposed portion of the positive electrode substrate and the exposed portion of the negative electrode substrate by resistance welding. Then, the collectors and connection terminals 22A and 22B are fixed to the sealing plate 17 through insulating plates 34 and gaskets 35 (refer to FIG. 5). Finally, the electrode group integrally formed with the sealing plate 17 is inserted into the outer can 15, and then the sealing plate 17 is fitted into the mouth portion 16 of the outer can 15; then, joining section between the circumference of the sealing plate 17 and the outer can 15 is laser-welded; then, after pouring in a predetermined amount of an electrolyte of predetermined composition through an electrolyte pour hole (not shown), the electrolyte pour hole is sealed up; and thus the prismatic secondary batteries 11 to 14 are completed. As an example, the electrolyte may be a nonaqueous electrolyte which is a 1 mole/L solution of LiPF₆ dissolved into a solvent made by mixing ethylene carbonate and diethyl carbonate in the proportion of 3:7 by volume.

Next, a structure of the negative electrode terminal 19 will be described with reference to FIGS. 1 to 3. As shown in FIG. 2, the negative electrode terminal 19 has a terminal plate 20A that is connected to the connection terminal 22A at one end and connected to an external terminal at the other end, and an insulating material 21A that electrically insulates the terminal plate 20A from the sealing plate 17. As shown in FIG. 3A, this terminal plate 20A is formed by an electrically conductive metal plate of an elongated rectangular shape having opposing long sides and short sides with a predetermined thickness, made of, for example, nickel-plated copper. The lengths of the long side and the short side are L1 and L2, respectively. The length L1 of the long side is smaller than a length L3 of the insulating material 21A to be described later, and the length L2 of the short side is smaller than a length L5 of the same.

As shown in FIG. 3B, this terminal plate 20A is provided at one end thereof with a connection hole 20a into which the connection terminal 22A connected to the collector is inserted, and is fixed at the other end thereof with a bolt 23A having a predetermined thickness and height by welding or other method. This bolt 23A serves as an external terminal, to which a connecting bus bar 30 (refer to FIG. 1) is fastened. Note that, although the present embodiment has exemplified the battery 12 using the bolt 23A, a nut or other known fastener may be used.

The insulating material 21A has a connecting portion 24A that is connected in contact with an adjacent battery with a space of a predetermined distance, and a fixing portion 25A that projects perpendicularly from a central part of one side of this connecting portion to be mechanically fixed to the sealing plate 17 by the connection terminal 22A. The insulating material 21A is formed by a plate-shaped body with a predetermined thickness having substantially a T-shape, as viewed from the top, made of an electrically insulating high-strength material such as polycarbonate. The connecting portion 24A is composed of an elongated rectangular plate-like strip having a predetermined length L4 and width L31, and at both ends in the longitudinal direction, has connection contact sides 26A that are connected in contact with similar insulating materials 21B (refer to FIG. 4C) of other adjacent batteries. Each of the connection contact sides 26A is formed with each of recessed portions 27 of a semicircular shape. These semicircular recessed portions 27 have a size adapted to receive protruding portions 31 (refer to FIG. 4C) of the similar insulating materials 21B of other adjacent batteries. The recessed portions 27 and the protruding portions 31 correspond to complementary-shaped connection contact portions of the invention. The fixing portion 25A is formed by an elongated rectangular plate-like strip having a predetermined length L32 and width L5. This fixing portion 25A is formed at one end thereof with a fixing hole 25a that is communicated with the connection hole 20a of the terminal plate 20A, and also formed at the bottom thereof with a ring-shaped projection 21a for positioning in the position corresponding to the bolt 23A of the terminal plate 20A. In addition, the lower end of the fixing hole 25a is formed with an expanded diameter portion 25a′ in which the gasket 35 (refer to FIG. 5) is installed.

Moreover, the upper surface of the insulating material 21A is formed with a recessed hole 29A of a predetermined depth, across the connecting portion 24A and the fixing portion 25A. The terminal plate 20A is fitted into this recessed hole 29A and fixed in place, thus being prevented from turning relative to the insulating material 21A. This insulating material 21A has an overall longitudinal length of L3. The connecting portion 24A has a longitudinal length of L4 and a width of L31. The fixing portion 25A has a width of L5 and a length of L32. The width L5 of the fixing portion 25A is substantially the same as, or slightly larger or smaller than, the width of the sealing plate 17. In addition, the overall longitudinal length L3 of the fixing portion 25A is a half or less of the longitudinal length of the sealing plate 17.

Moreover, a portion of the connecting portion 24A projecting from the fixing portion 25A has a length of L41, which is substantially a half of a gap G (refer to FIG. 1) between the adjacent batteries to be connected. That is, if the width L5 of the fixing portion 25A is made to be substantially the same as the width of the sealing plate 17, the length L41 of the connecting portion 24A results in ½ of the gap G. Consequently, by setting this length L41 to a predetermined value specified in advance, the gap G between the adjacent batteries is set to an optimum value, thereby efficiently radiating the heat generated from the batteries when using or charging the batteries, thus enabling charge and discharge at a maximum power. Although the example has been shown in which the connecting portion 24A is provided with the portions projecting from both sides in the longitudinal direction of the sealing plate 17, it is preferable to prepare also insulating materials that are formed with connecting portions at only one of the sides thereof. These insulating materials formed with connecting portions at only one of the sides are used in batteries at both ends in the case of modularization. Furthermore, although the connecting portion 24A has been provided at a location corresponding to the bolt 23A, this location may be changed to the side of the fixing portion 25A.

Next, a specific structure of the positive electrode terminal 18 will be described with reference to FIG. 4. The positive electrode terminal 18 only differs from the negative electrode terminal 19 in that a part of a structure of the insulating material 21B electrically insulating a terminal plate 20B from the sealing plate 17 is different, all other structures being the same. Therefore, common components are designated by substantially the same reference numerals with alphabetical portions thereof changed from “A” to “B” or “a” to “b” to omit duplicate description, and the different structure will be described in detail.

The positive electrode terminal 18 has the terminal plate 20B made, for example, of aluminum-copper clad material that is connected to the connection terminal 22B (refer to FIG. 2) at one end, and the insulating material 21B that electrically insulates this terminal plate 20B from the sealing plate 17. This insulating material 21B differs from the insulating material 21A of the negative electrode terminal 19 only in the shape of each of the connection contact sides 26A of the connecting portion 24A. That is, connection contact sides 26B of the insulating material 21B are formed with the protruding portions 31 instead of the recessed portions 27 of the insulating material 21A of the negative electrode terminal 19. Each of the protruding portions 31 of the insulating material 21B has a size adapted to fit into the recessed portion 27 of the insulating material 21A of the negative electrode terminal 19 of the adjacent battery. Because the insulating material 21A of the negative electrode terminal 19 and the insulating material 21B of the positive electrode terminal 18 are provided with the recessed portions 27 and the protruding portions 31, respectively, as described above, each of the protruding portions 31 of the insulating material 21B of the positive electrode terminal 18 fits into each of the recessed portions 27 of the insulating material 21A of the negative electrode terminal 19 provided in the adjacent battery, when modularizing the plurality of batteries. Therefore, the adjacent batteries can be connected in series without a mistake in polarity. That is, because the recessed portion 27 of the insulating material 21A of the negative electrode terminal 19 and the protruding portion 31 of the insulating material 21B of the positive electrode terminal 18 have shapes to complement each other, the both portions cannot fit with each other if the polarities of the adjacent batteries are wrong, thus facilitating identification of an erroneous connection.

Although the present embodiment has shown the example of providing the recessed portions 27 on the insulating material 21A of the negative electrode terminal 19 and the protruding portions 31 on the insulating material 21B of the positive electrode terminal 18, these structures may be interchanged. In addition, the structure of the complementary-shaped connection contact portions may use other known shapes of a complementary relation with each other instead of the protruding portions and the recessed portions, or, furthermore, may use shapes to be fitted into connection that is not easily disconnected.

Next, methods of installing the positive electrode terminal 18 and the negative electrode terminal 19 will be described with reference to FIG. 5. For example, the negative electrode terminal 19 is installed on the sealing plate 17 of the battery by using the terminal plate 20A and the insulating material 21A described above, by following the procedure below. As a pre-preparation, the bolt 23A is fixed to one end of the terminal plate 20A by resistance welding or other method. Note that it is preferable to attach in advance a metallic material, such as copper or nickel, different from that of the terminal plates 20A and 20B, in order to reduce contact resistance between the terminal plates 20A and 20B, respectively, and the bus bar 30, or to prevent corrosion of them. The portion identified with reference numeral 32 in FIG. 5 indicates the portion of this different metallic material. In addition, the connection terminal 22A having an inverse T-shape in the cross-sectional view is prepared and electrically connected to a negative electrode collector 33 in advance. This connection terminal 22A used in this embodiment is composed, for example, of a circular disc-shaped stopper portion 22a having a larger diameter than that of a through-hole 36 provided in the sealing plate 17, and of a projecting portion 22b composed of a rod-shaped body that is vertically erected from a substantial center of this stopper portion 22a to a predetermined height. Then, the insulating plate 34 and the gasket 35 are installed on the projecting portion 22b in advance.

After this pre-preparation has been completed, the insulating material 21A and the terminal plate 20A are placed in this order on the upper surface of the sealing plate 17, and a ring-shaped groove 17a provided on the sealing plate 17 and the ring-shaped projection 21a formed on the bottom surface of the insulating material 21A are fitted with each other, while the through-hole 36 provided in the sealing plate 17 is aligned to the fixing hole 25a of the insulating material 21A and to the connection hole 20a of the terminal plate 20A. Next, the projecting portion 22b of the connection terminal 22A is passed from the back surface of the sealing plate 17 through the through-hole 36, and inserted into the fixing hole 25a and the connection hole 20a. Then, a top portion of the projecting portion 22b of the connection terminal 22A is laser-welded to be fixed to the terminal plate 20A, thus the negative electrode terminal 19 being installed on the sealing plate 17.

Although illustration of the positive electrode terminal 18 is omitted, the positive electrode terminal 18 is installed in a manner electrically insulated from the sealing plate 17 by using the terminal plate 20B, the insulating material 21B, and the connection terminal 22B having an inverse T-shape in the cross-sectional view (refer to FIG. 2), in the same method as that for the negative electrode terminal 19. After the positive electrode terminal 18 and the negative electrode terminal 19 have been installed on the sealing plate 17, the connecting portions 24B and 24A of the corresponding insulating materials 21B and 21A of the positive electrode terminal 18 and the negative electrode terminal 19, respectively, are arranged in a manner projecting in a direction perpendicular to the longitudinal direction of the sealing plate 17, as shown in FIG. 2.

The modularization using the above-described battery is performed in the following method. A plurality of the single batteries 12 shown in FIG. 2, such as the four batteries 11 to 14, are prepared and arranged as shown in FIG. 1. This arrangement is achieved by fitting with each other the protruding portion 31 and the recessed portion 27 of the corresponding insulating materials 21B and 21A of the positive electrode terminal 18 and the negative electrode terminal 19, respectively, where the fitting is performed between each adjacent pair of the batteries 11 to 14. In this fitting, because each of the protruding portions 31 and each of the recessed portions 27 have a complementary relation with each other, a connection by contact between the same shapes, such as between protruding portions or between recessed portions, is impossible. Therefore, the batteries can easily be arranged without a mistake in the polarity of each battery. After this arrangement, both bolts 23B and 23A of the positive electrode terminal 18 and negative electrode terminal 19, respectively, of the batteries 11 to 14 are inserted into the through-holes of the connecting bus bar 30, and then fastened by nuts, which are not shown. When the nuts are turned by a tool in the fastening operation described above, the insulating materials 21A and 21B, and the terminal plates 20A and 20B are not turned in spite of the turning of the nuts, because the insulating materials 21B and 21A of the positive electrode terminal 18 and negative electrode terminal 19, respectively, of the batteries 11 to 14 are connected in contact with each other in the form of a straight line, thereby being unable to move. As a result, the connection terminals 22A and 22B connected to the terminal plates 20A and 20B, respectively, are scarcely subjected to a turning force, thereby the electrical connection state between the terminal plates 20A and 20B and the connection terminals 22A and 22B, respectively, is prevented from being subjected to harmful effects.

In addition, because the connecting portions 24B and 24A of the corresponding insulating materials 21B and 21A of the positive electrode terminal 18 and the negative electrode terminal 19, respectively, project by a predetermined length in a direction perpendicular to the longitudinal direction of the sealing plate 17 between each adjacent pair of the connected batteries 11 to 14, the predetermined gap G is provided. By this gap G, it becomes possible to efficiently radiate the heat generated from the batteries when using or charging the batteries, thus enabling the batteries to be charged or discharged at a desired power.

In the negative electrode terminal 19 of the embodiment described above, the bolt 23A that is fixed to the terminal plate 20A and the projecting portion 22b of the connection terminal 22A that is connected to the collector are horizontally spaced apart from each other by some distance; that is, the axes of each of the terminals are spaced apart from each other. With the structure as described above, rotation of the connection terminal 22A is difficult to occur when tightening the bolt-nut assembly because the rotational axis when tightening the bolt-nut assembly is not the same as the rotational axis of the connection terminal 22A. Consequently, the connection of the connection terminal 22A with the collector can be prevented from suffering harmful effects such as a poor connection or increase in internal resistance due to the poor connection, or, furthermore, a poor seal between the negative electrode terminal 19 and the sealing plate 17. Note that the above description applies similarly to the case of the positive electrode terminal 18.

The invention has been explained in detail according to the embodiment described above. However, the invention is not limited to this, but may be changed or modified by those having ordinary knowledge in the technical field to which the present invention belongs, without departing from the thought and spirit of the invention. This battery technology can be applied not only to a lithium ion battery, but also to other prismatic secondary batteries such as a nickel-metal hydride rechargeable battery or a nickel-cadmium rechargeable battery. Moreover, although the above-described embodiment has shown the example using the electrode assembly formed by spirally winding the positive electrode plate and the negative electrode plate with the separator interposed therebetween, the invention can be applied to an electrode assembly formed by stacking the positive electrode plate and the negative electrode plate with the separator interposed therebetween.

What is claimed is:

1. A prismatic secondary battery comprising:
a battery outer can of a prismatic shape that has a bottom and an open mouth at the top;
an electrode assembly that is housed in the battery outer can and formed by stacking or spirally winding a positive electrode plate and a negative electrode plate with a separator interposed therebetween; and
a sealing plate that seals the mouth and is provided on an upper surface with a positive electrode terminal and a negative electrode terminal,
the positive electrode terminal and the negative electrode terminal being provided with terminal plates that are electrically connected to the positive electrode plate and the negative electrode plate, respectively, and with insulating materials that electrically insulate the terminal plates from the sealing plate;
the insulating materials of the positive electrode terminal and the negative electrode terminal being provided with a positive electrode connecting portion and a negative electrode connecting portion, respectively, that have connection contact portions having shapes complementary with each other; and
the shapes of the positive electrode connecting portion and the negative electrode connecting portion being such that, when a plurality of the prismatic secondary batteries are arranged in parallel so that adjacent terminals have different polarities from each other, the positive electrode connecting portion and the negative electrode connecting portion of one prismatic secondary battery are connected in contact with the negative electrode connecting portion and the positive electrode connecting portion, respectively, of an adjacent prismatic secondary battery, through the connection contact portions having the shapes complementary with each other.

2. The prismatic secondary battery according to claim 1, wherein the insulating materials have projecting portions that protrude the positive electrode connecting portion and the negative electrode connecting portion by a certain predetermined length, from at least one side in the longitudinal direction of the sealing plate, toward a direction perpendicular to the longitudinal direction of the sealing plate, and wherein connection contact sides at the ends of the projecting portions are formed with the connection contact portions having the shapes complementary with each other.

3. The prismatic secondary battery according to claim 2, wherein the projecting portions protrude by the same length from both sides in the longitudinal direction of the sealing plate, toward a direction perpendicular to the longitudinal direction of the sealing plate.

4. The prismatic secondary battery according to claim 1, wherein the terminal plates are provided with connection portions to which collectors are connected and with external terminals that are externally connected in positions spaced apart from the connection portions, and wherein the positive electrode connecting portion and the negative electrode connecting portion of the insulating materials are provided at locations corresponding to the connection portions or to the external terminals.

5. The prismatic secondary battery according to claim 4, wherein the external terminals are composed of fasteners that are selected from bolts or nuts.

6. The prismatic secondary battery according to claim 1, wherein one and the other of the connection contact portions having the shapes complementary with each other are a recessed portion and a protruding portion, respectively.

7. The prismatic secondary battery according to claim 1, wherein the terminal plates are fixed in place by anti-rotation units formed on the insulating materials.

8. A battery module containing a plurality of prismatic secondary batteries, each of the batteries comprising:
a battery outer can of a prismatic shape that has a bottom and an open mouth at the top;
an electrode assembly that is housed in the battery outer can and formed by stacking or spirally winding a positive electrode plate and a negative electrode plate with a separator interposed therebetween; and
a sealing plate that seals the mouth and is provided on an upper surface with a positive electrode terminal and a negative electrode terminal,
the positive electrode terminal and the negative electrode terminal of the prismatic battery being provided with terminal plates that are electrically connected to the positive electrode plate and the negative electrode plate, respectively, and with insulating materials that electrically insulate the terminal plates from the sealing plate;
the insulating materials of the positive electrode terminal and the negative electrode terminal being provided with a positive electrode connecting portion and a negative electrode connecting portion, respectively, that have connection contact portions having shapes complementary with each other;
the shapes of the positive electrode connecting portion and the negative electrode connecting portion being such that, when the plurality of prismatic secondary batteries are arranged in parallel so that adjacent terminals have different polarities from each other, the positive electrode connecting portion and the negative electrode connecting portion of one prismatic secondary battery are connected in contact with the negative electrode connecting portion and the positive electrode connecting portion, respectively, of an adjacent prismatic secondary battery, through the connection contact portions having the shapes complementary with each other; and
the plurality of prismatic batteries being connected in series in such a manner that the positive electrode connecting portion and the negative electrode connecting portion that are adjacent to each other are connected in contact with each other, and different polarity terminals of the prismatic secondary batteries that are adjacent to each other are firmly connected to each other by a connecting bus bar.

9. The battery module according to claim 8, wherein the insulating materials of the prismatic battery have projecting portions that protrude the positive electrode connecting portion and the negative electrode connecting portion by a certain predetermined length, from at least one side in the longitudinal direction of the sealing plate, toward a direction perpendicular to the longitudinal direction of the sealing plate, and wherein connection contact sides at the ends of the projecting portions are formed with the connection contact portions having the shapes complementary with each other.

10. The battery module according to claim 9, wherein the projecting portions of the prismatic battery protrude by the same length from both sides in the longitudinal direction of the sealing plate, toward a direction perpendicular to the longitudinal direction of the sealing plate.

11. The battery module according to claim 8, wherein the terminal plates of the prismatic battery are provided with connection portions to which collectors are connected and with external terminals that are externally connected in positions spaced apart from the connection portions, and wherein the positive electrode connecting portion and the negative electrode connecting portion of the insulating materials are provided at locations corresponding to the connection portions or to the external terminals.

12. The battery module according to claim 11, wherein the external terminals of the prismatic battery are composed of fasteners that are selected from bolts or nuts.

13. The battery module according to claim 8, wherein one and the other of the connection contact portions having the shapes complementary with each other in the prismatic battery are a recessed portion and a protruding portion, respectively.

14. The battery module according to claim 8, wherein the terminal plates of the prismatic battery are fixed in place by anti-rotation units formed on the insulating materials.
